(19) United States
(12) Patent Application Publication
(10) Pub. No.: US 2020/0260122 A1
(43) Pub. Date: Aug. 13, 2020

(54) APPARATUS AND METHOD FOR PICTURE CODING WITH ASYMMETRIC PARTITIONING

(71) Applicant: Huawei Technologies Co., Ltd., Shenzhen (CN)

(72) Inventors: ALEXEY KONSTANTINOVICH FILIPPOV, Moscow (RU); Alexander Alexandrovich KARABUTOV, Moscow (RU); Shan LIU, Shenzhen (CN); VASILY ALEXEEVICH RUFITSKIY, Moscow (RU)

(21) Appl. No.: 16/859,753

(22) Filed: Apr. 27, 2020

Related U.S. Application Data
(63) Continuation of application No. PCT/RU2017/000795, filed on Oct. 27, 2017.

(51) Int. Cl. H04N 19/96; H04N 19/176; H04N 19/119

(52) U.S. Cl. CPC H04N 19/96; H04N 19/119; H04N 19/176

(57) ABSTRACT

An apparatus and a method for image coding with asymmetric partitioning are disclosed. Instead of a conventional approach of using partitioning mechanisms such as QTBT and Multi-Type Tree (MTT), an asymmetric partitioning mechanism that can provide a good performance/complexity tradeoff is introduced. This allows constraining parameters of the asymmetric partitioning mechanism to exclude modes that appear not frequently, thereby allowing keeping encoder-side complexity low and avoiding signaling overhead.

### CROSS-REFERENCE TO RELATED APPLICATIONS

This application is a continuation of International Application No. PCT/RU2017/000795, filed on Oct. 27, 2017, the disclosure of which is hereby incorporated by reference in its entirety.

### TECHNICAL FIELD

The present disclosure relates to the field of picture coding. Particularly, the disclosure relates to improving coding and decoding of still pictures and video with asymmetric partitioning.

### BACKGROUND

Digital video communication and storage applications are implemented by a wide range of digital devices, such as digital cameras, cellular radio telephones, laptops, broadcasting systems, video teleconferencing systems, etc. One of the most important and challenging tasks of these applications is video compression. The task of video compression is typically complex and constrained by two contradicting parameters: compression efficiency and computational complexity. Current video coding standards, such as ITU-T H.264 (or Advanced Video Coding, AVC) and ITU-T H.265 (or High Efficiency Video Coding, HEVC) aim to provide a good tradeoff between these parameters.

The current video coding standards are based on partitioning a source picture into blocks. Herein, partitioning refers to covering a picture with a set of blocks. Processing of these blocks depends on their size, spatial position and a coding mode specified by an encoder. Coding modes can be classified into two groups according to a prediction type: intra- and inter-prediction modes. Intra-prediction modes use pixels of the same picture to generate reference samples to calculate the prediction values for the pixels of the block being reconstructed. Intra-prediction is also referred to as spatial prediction. Inter-prediction modes are designed for temporal prediction and uses reference samples of previous or next pictures to predict pixels of the block of the current picture. After a prediction stage, transform coding is performed for a prediction error that is the difference between an original signal and its prediction. Then, the transform coefficients and side information are encoded using an entropy coder.

However, there are situations in which symmetric partitioning cannot e.g. accurately divide a block into sub-blocks along an edge contained in a picture. This may decrease compression efficiency of partitioning mechanisms used in a video codec. Furthermore, introducing asymmetric partitioning may result in signaling overhead. For example, Quad-Tree Binary Tree (QTBT) partitioning can provide both square and rectangular blocks but at the cost of signaling overhead and increased computational complexity at the encoder side.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an object of the invention to provide improved coding and decoding of still pictures and video with asymmetric partitioning. The foregoing and other objects are achieved by the features of the independent claims. Further implementation forms are apparent from the dependent claims, the description and the figures.

According to a first aspect, a picture coding apparatus is provided. The picture coding apparatus is configured to receive partitioning information for a current block of picture data. The picture coding apparatus is further configured to determine or perform a partitioning process for the current block of picture data. The partitioning process comprises asymmetrically partitioning the current block of picture data into a first first-level sub-block of picture data and a second first-level sub-block of picture data in response to the received partitioning information indicating that the current block of picture data is to be partitioned. The first first-level sub-block is smaller than the second first-level sub-block. The partitioning process further comprises symmetrically partitioning indicated ones of the at least one of the first first-level sub-block of picture data or the second first-level sub-block of picture data into at least two second-level sub-blocks of picture data in response to the received partitioning information further indicating that at least one of the first first-level sub-block of picture data or the second first-level sub-block of picture data is to be partitioned. The direction of the symmetrical partitioning is dependent on the direction of the asymmetrical partitioning and on which of the first first-level sub-block of picture data and the second first-level sub-block of picture data is the subject of the symmetrically partitioning.

In a further implementation form of the first aspect, the partitioning process further comprises refraining from further partitioning any of the first-level or second-level sub-blocks of picture data.

In a further implementation form of the first aspect, the first first-level sub-block being smaller than the second first-level sub-block comprises the side-length of the first first-level sub-block of picture data being smaller than the side-length of the second first-level sub-block of picture data in a direction perpendicular to the direction of the asymmetrical partitioning.

In a further implementation form of the first aspect, the symmetrical partitioning of the first first-level sub-block of picture data comprises symmetrically partitioning the first first-level sub-block of picture data into the at least two second-level sub-blocks of picture data in a direction perpendicular to the direction of the asymmetrical partitioning.

In a further implementation form of the first aspect, the symmetrical partitioning of the second first-level sub-block of picture data comprises symmetrically partitioning the second first-level sub-block of picture data into the at least two second-level sub-blocks of picture data in a direction parallel to the direction of the asymmetrical partitioning.

In a further implementation form of the first aspect, the side-length of the second first-level sub-block of picture data in the direction perpendicular to the direction of the asymmetrical partitioning is dividable into three portions, each of which has a side-length of a power of two.

In a further implementation form of the first aspect, the asymmetrical partitioning comprises asymmetrical binary tree partitioning.

In a further implementation form of the first aspect, the symmetrical partitioning comprises symmetrical binary tree partitioning or symmetrical triple tree partitioning.

In a further implementation form of the first aspect, the partitioning information comprises information on a partitioning configuration of the current block of picture data.

In a further implementation form of the first aspect, the picture coding apparatus comprises a picture encoding apparatus.

In a further implementation form of the first aspect, the picture coding apparatus comprises a picture decoding apparatus.

In a further implementation form of the first aspect, the current block of picture data is included in a video sequence picture or a still picture.

According to a second aspect, a method of picture coding is provided. The method comprises

receiving, at a picture coding apparatus, partitioning information for a current block of picture data. The method further comprises determining or performing, by the picture coding apparatus, a partitioning process for the current block of picture data. The partitioning process comprises asymmetrically partitioning the current block of picture data into a first first-level sub-block of picture data and a second first-level sub-block of picture data in response to the received partitioning information indicating that the current block of picture data is to be partitioned. The first first-level sub-block is smaller than the second first-level sub-block. The partitioning process further comprises symmetrically partitioning indicated ones of the at least one of the first first-level sub-block of picture data or the second first-level sub-block of picture data into at least two second-level sub-blocks of picture data in response to the received partitioning information further indicating that at least one of the first first-level sub-block of picture data or the second first-level sub-block of picture data is to be partitioned. The direction of the symmetrical partitioning is dependent on the direction of the asymmetrical partitioning and on which of the first first-level sub-block of picture data and the second first-level sub-block of picture data is the subject of the symmetrically partitioning.

In a further implementation form of the second aspect, the partitioning process further comprises refraining from further partitioning any of the first-level or second-level sub-blocks of picture data.

In a further implementation form of the second aspect, the first first-level sub-block being smaller than the second first-level sub-block comprises the side-length of the first first-level sub-block of picture data being smaller than the side-length of the second first-level sub-block of picture data in a direction perpendicular to the direction of the asymmetrical partitioning.

In a further implementation form of the second aspect, the symmetrical partitioning of the first first-level sub-block of picture data comprises symmetrically partitioning the first first-level sub-block of picture data into the at least two second-level sub-blocks of picture data in a direction perpendicular to the direction of the asymmetrical partitioning.

In a further implementation form of the second aspect, the symmetrical partitioning of the second first-level sub-block of picture data comprises symmetrically partitioning the second first-level sub-block of picture data into the at least two second-level sub-blocks of picture data in a direction parallel to the direction of the asymmetrical partitioning.

In a further implementation form of the second aspect, the side-length of the second first-level sub-block of picture data in the direction perpendicular to the direction of the asymmetrical partitioning is dividable into three portions, each of which has a side-length of a power of two.

In a further implementation form of the second aspect, the asymmetrical partitioning comprises asymmetrical binary tree partitioning.

In a further implementation form of the second aspect, the symmetrical partitioning comprises symmetrical binary tree partitioning or symmetrical triple tree partitioning.

In a further implementation form of the second aspect, the partitioning information comprises information on a partitioning configuration of the current block of picture data.

In a further implementation form of the second aspect, the picture coding apparatus comprises a picture encoding apparatus.

In a further implementation form of the second aspect, the picture coding apparatus comprises a picture decoding apparatus.

In a further implementation form of the second aspect, the current block of picture data is included in a video sequence picture or a still picture.

According to a third aspect, a computer program is provided. The computer program comprises program code configured to perform the method according to the second aspect, when the computer program is executed on a computing device.

Many of the attendant features will be more readily appreciated as they become better understood by reference to the following detailed description considered in connection with the accompanying drawings.

### BRIEF DESCRIPTION OF THE DRAWINGS

In the following, example embodiments are described in more detail with reference to the attached figures and drawings, in which:

FIG. 1 is a block diagram showing an example embodiment of a video encoding apparatus;

FIG. 2 is a block diagram showing an example embodiment of a video decoding apparatus;

FIG. 3A is another block diagram showing another example embodiment of a video encoding apparatus;

FIG. 3B is another block diagram showing another example embodiment of a video decoding apparatus;

FIG. 4 is a flow diagram of an example method involving picture coding with asymmetric partitioning;

FIGS. 5A-5G are diagrams illustrating various partitioning schemes;

FIG. 6 is a diagram illustrating two-level partitioning according to an example embodiment;

FIGS. 7A-7B are diagrams further illustrating two-level partitioning according to example embodiments;

FIG. 8 is a diagram further illustrating two-level partitioning according to yet another example embodiment;

FIG. 9 is a flow diagram illustrating partitioning decision-making according to an example embodiment;

FIG. 10 is a flow diagram illustrating a decoding process according to an example embodiment;

FIG. 11 is a diagram illustrating typical statistics related to various partitionings;

FIGS. 12A-12B are diagrams illustrating various signaling schemes; and

FIG. 13 is another diagram further illustrating an example of partitioning decisions.

In the following, identical reference signs refer to identical or at least functionally equivalent features.

### DETAILED DESCRIPTION OF THE EMBODIMENTS

In the following description, reference is made to the accompanying drawings, which form part of the disclosure, and in which are shown, by way of illustration, specific aspects in which the present invention may be placed. It is understood that other aspects may be utilized and structural or logical changes may be made without departing from the scope of the present invention. The following detailed description, therefore, is not to be taken in a limiting sense, as the scope of the present invention is defined be the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

Video coding typically refers to the processing of a sequence of pictures, which form the video or video sequence. Instead of the term picture the terms image or frame may be used/are used synonymously in the field of video coding. Each picture is typically partitioned into a set of non-overlapping blocks. The encoding/coding of the video is typically performed on a block level where e.g. inter frame prediction or intra frame prediction are used to generate a prediction block, to subtract the prediction block from the current block (block currently processed/to be processed) to obtain a residual block, which is further transformed and quantized to reduce the amount of data to be transmitted (compression) whereas at the decoder side the inverse processing is applied to the encoded/compressed block to reconstruct the block (video block) for representation.

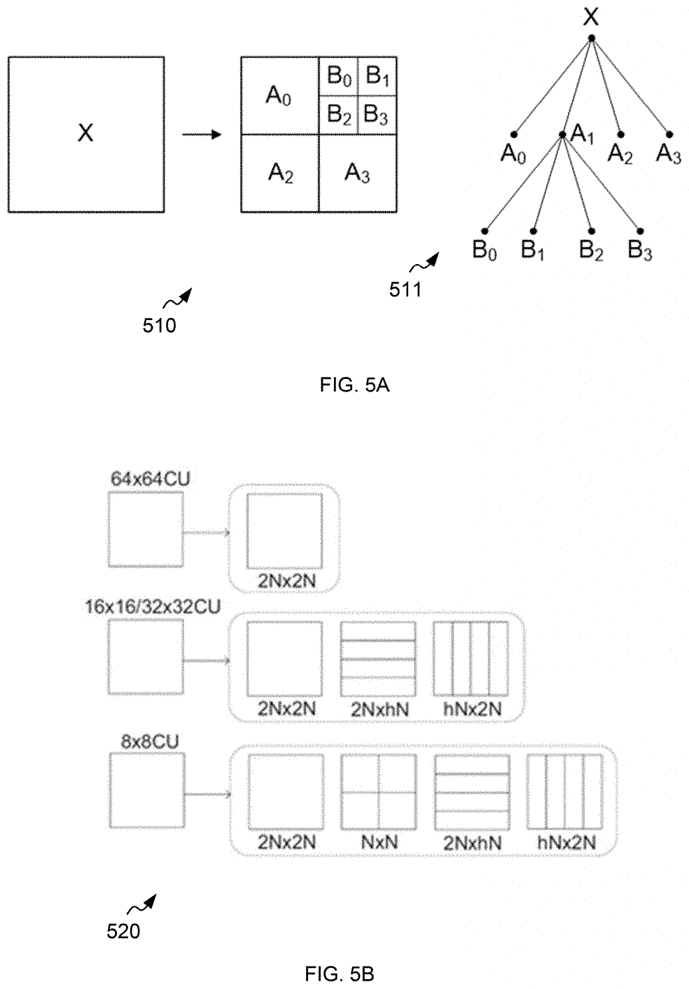

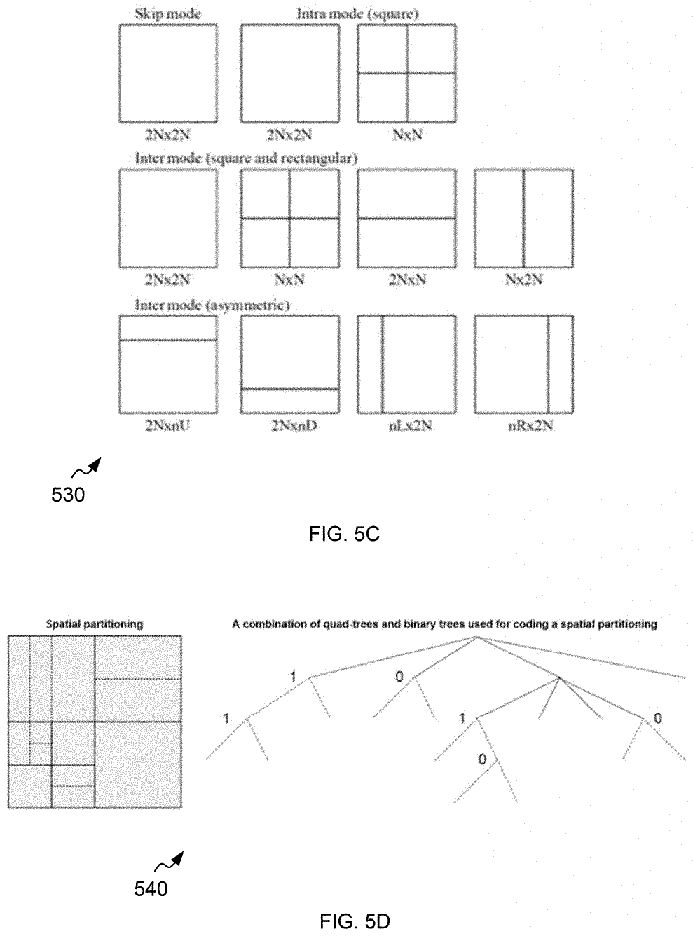

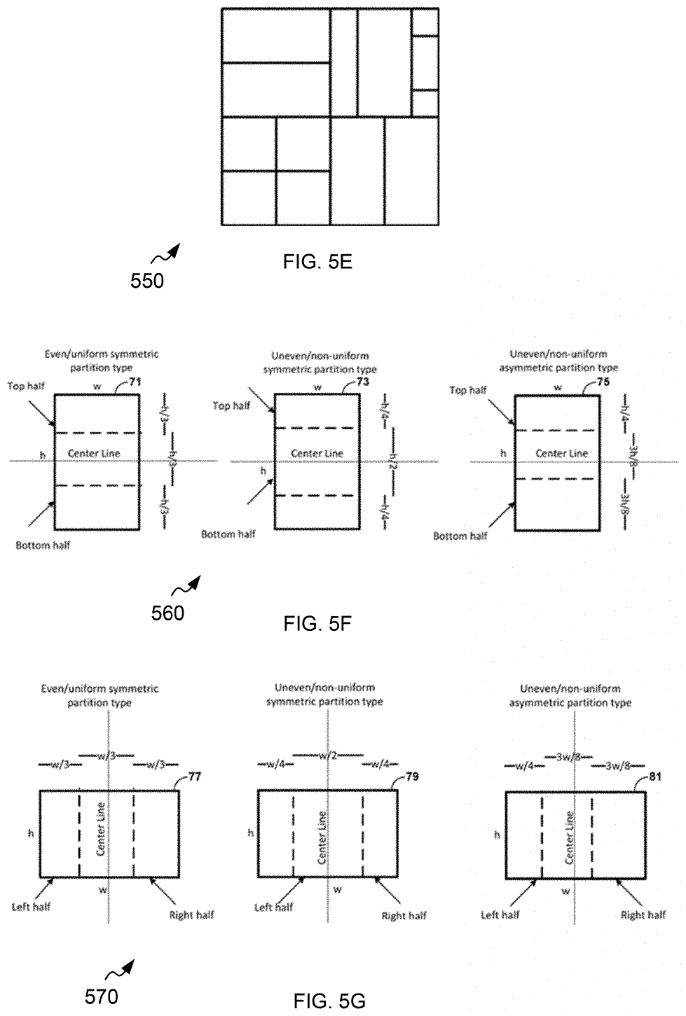

In the following, partitioning schemes used in HEVC are described based on FIGS. 5A to 5G.

In the HEVC standard, a picture is typically split into largest coding units (LCU). Each of these units may be hierarchically partitioned further. Encoding and parsing processes for the hierarchically partitioned blocks are recursive procedures in which a recursion step may be represented by a node of a tree structure.

For example, as shown in diagram 510 of FIG. 5A, a square block X may be divided into four square sub-blocks A₀ to A₃. In this example, the sub-block A₁ is further split into four sub-blocks B₀ to B₃. Each of the nodes of the tree shown in diagram 511 corresponds to a respective square block in the hierarchically partitioned block X. There is only one possible way to cover a square block by four equally sized square blocks. Hence, encoding split decisions for each of the nodes of this tree are enough to restore partitioning structure on the decoder side. Each node within a tree-based representation has its associated split depth, i.e. a number of nodes in the path from this node to the root of the tree. For example, the split depth for each of the nodes B₀ to B₃ is two, whereas the split depth for each of the nodes A₀ to A₃ is one. Usually, the split depth is restricted by a parameter called maximum split depth which is usually predefined at both encoder and decoder sides. When the maximum split depth is reached, a current block is not split further. A node that is not split further is called a leaf.

Starting from the HEVC/H.265 standard, the Quad-Tree (QT) partitioning shown in FIG. 5A has been mainly used to divide a picture into blocks that always has a square shape. In addition to QT, short-distance intra-prediction (SDIP) shown in diagram 520 of FIG. 5B and asymmetric motion partitioning (AMP) shown in diagram 530 of FIG. 5C have been considered as candidates to be included into the HEVC/H.265 specification for intra- and inter-coding mechanisms, respectively. However, only AMP has been adopted into the HEVC/H.265 specification. As shown in FIGS. 5B and 5C, applying any of these two auxiliary partitioning mechanisms may result in generating rectangular blocks. However, asymmetric partitions are only available in AMP.

For Joint Exploration Model (JEM), starting with software version 3.0, a new partitioning mechanism based on both QT and BT called Quad-Tree Binary-Tree (QTBT) has been introduced. As shown in diagram 540 of FIG. 5D, QTBT partitioning can provide both square and rectangular blocks. However, signaling overhead and increased computational complexity at the encoder side result from the QTBT partitioning as compared to prior QT based partitioning used in the HEVC/H.265 standard.

Multi-type tree (MTT) combines QT, BT and TT partitioning mechanisms, as shown in diagram 550 FIG. 5E. As shown in diagrams 550 to 570 of FIGS. 5F to 5G, respectively, TT is a partitioning mechanism that divides a block into three partitions that can be equally or unequally sized. Subject to a selected partitioning option, TT can provide both symmetric and asymmetric partitioning.

However, there are issues with the embodiments of FIGS. 5A to 5G. For example, there may be situations in which symmetric partitioning cannot e.g. accurately divide a block into sub-blocks along an edge contained in a picture. This may decrease compression efficiency of partitioning mechanisms used in a video codec. Furthermore, introducing asymmetric partitioning in accordance with the embodiments of FIGS. 5A to 5G may result in signaling overhead.

In the following, asymmetric partitioning is described in video coding, however, the methods and apparatuses discussed may also be applied to individual pictures or images that need to be partitioned. In the following, the asymmetric partitioning may involve using Binary Tree (BT) and/or Triple Tree (TT) partitioning. Instead of a conventional approach of using partitioning mechanisms such as QTBT and Multi-Type Tree (MTT), an asymmetric partitioning mechanism that can provide a good performance/complexity tradeoff is introduced in the following. This allows constraining parameters of the asymmetric partitioning mechanism to exclude modes that appear not frequently, thereby allowing keeping encoder-side complexity low and avoiding signaling overhead.

The disclosed concepts provide an asymmetric partitioning mechanism that may have at least some of the following set of features:

1. A restricted maximum split depth that equals 2;

2. Predefined partitioning directions (e.g., either vertical or horizontal) for the second level split decisions; and

3. The available predefined partitioning directions at the second level are determined by partitioning decisions made at the previous (i.e. first) level.

Accordingly, the disclosed concepts allow e.g. the following advantages:
increased compression performance when integrating these concepts into a codec;
they can be used in several potential applications in hybrid video coding paradigms that are compatible with e.g. HEVC Reference Model (HM) software and the VPx (such as VP9) video codec family as well as the JEM software and the VPx/AV1 video codec families;
hardware and computational complexities are kept low at the decoder side;
easy integration with such partitioning mechanisms as QTBT and MTT, for example.

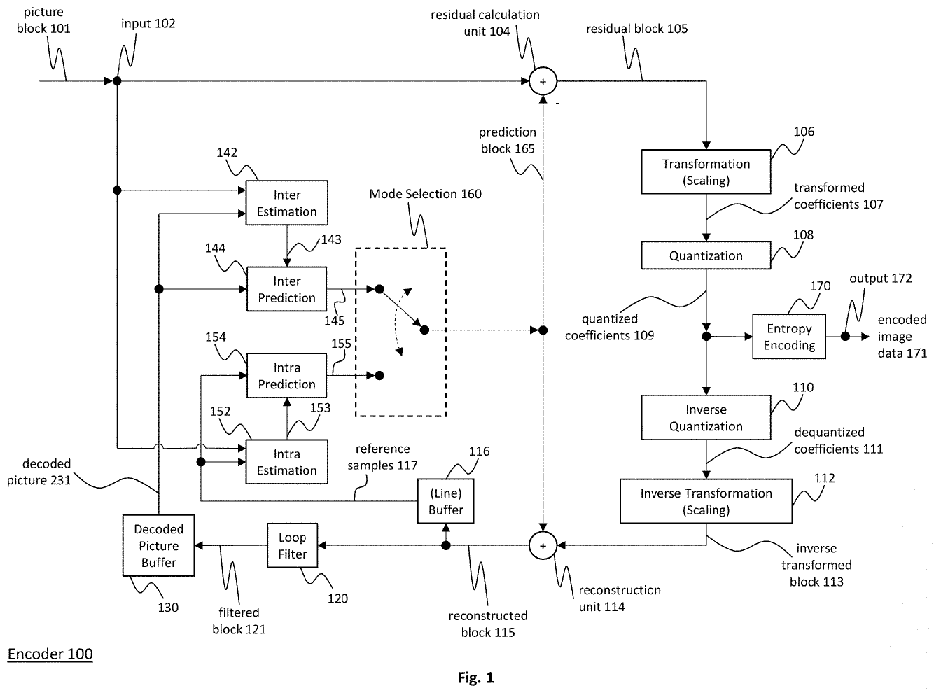

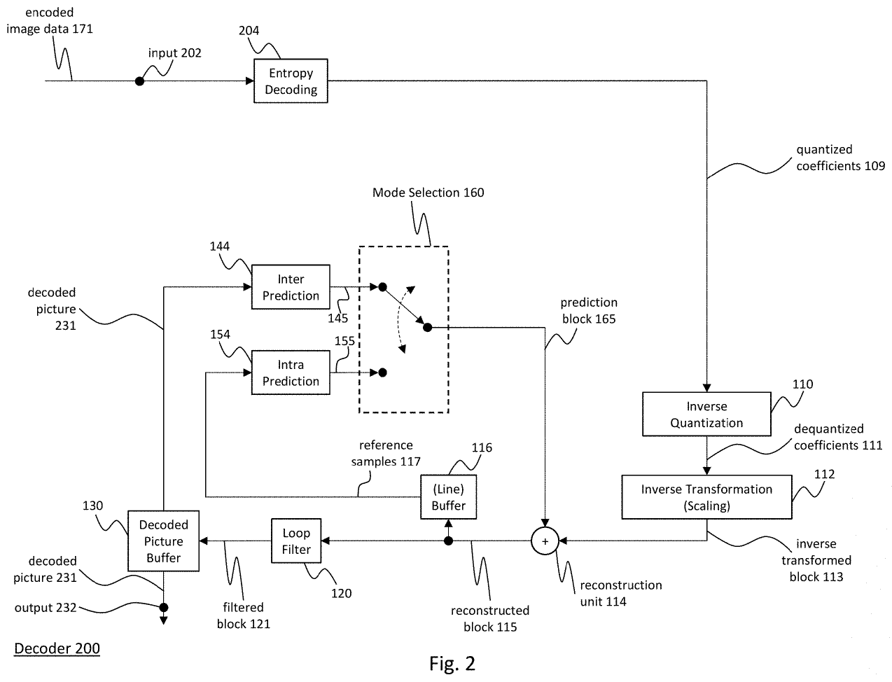

In the following, example embodiments of an encoder 100 and a decoder 200 are described based on FIGS. 1 and 2.

FIG. 1 shows an encoder 100, which comprises an input 102, a residual calculation unit 104, a transformation unit 106, a quantization unit 108, an inverse quantization unit 110, and inverse transformation unit 112, a reconstruction unit 114, a loop filter 120, a frame buffer 130, an inter estimation unit 142, an inter prediction unit 144, an intra estimation unit 152, an intra prediction unit 154, a mode selection unit 160, an entropy encoding unit 170, and an output 172.

The input 102 is configured to receive a picture block 101 of a picture (e.g. a still picture or picture of a sequence of pictures forming a video or video sequence). The picture block may also be referred to as a current picture block or a picture block to be coded, and the picture as a current picture or a picture to be coded.

The residual calculation unit 104 is configured to calculate a residual block 105 based on the picture block 101 and a prediction block 165 (further details about the prediction block 165 are provided later), e.g. by subtracting sample values of the prediction block 165 from sample values of the picture block 101, sample by sample (pixel by pixel) to obtain a residual block in the sample domain.

The transformation unit 106 is configured to apply a transformation, e.g. a discrete cosine transform (DCT) or discrete sine transform (DST), on the residual block 105 to obtain transformed coefficients 107 in a transform domain. The transformed coefficients 107 may also be referred to as transformed residual coefficients and represent the residual block 105 in the transform domain.

The quantization unit 108 is configured to quantize the transformed coefficients 107 to obtain quantized coefficients 109, e.g. by applying scalar quantization or vector quantization. The quantized coefficients 109 may also be referred to as quantized residual coefficients 109.

The inverse quantization unit 110 is configured to apply the inverse quantization of the quantization unit 108 on the quantized coefficients to obtain or regain dequantized coefficients 111. The dequantized coefficients 111 may also be referred to as dequantized residual coefficients 111.

The inverse transformation unit 112 is configured to apply the inverse transformation of the transformation applied by the transformation unit 106, e.g. an inverse discrete cosine transform (DCT) or inverse discrete sine transform (DST), to obtain an inverse transformed block 113 in the sample domain. The inverse transformed block 113 may also be referred to as inverse transformed dequantized block 113 or inverse transformed residual block 113.

The reconstruction unit 114 is configured to combine the inverse transformed block 113 and the prediction block 165 to obtain a reconstructed block 115 in the sample domain, e.g. by sample-wise adding the sample values of the decoded residual block 113 and the sample values of the prediction block 165.

The buffer unit 116 (or short “buffer” 116), e.g. a line buffer 116, is configured to buffer or store the reconstructed block, e.g. for intra estimation and/or intra prediction.

The loop filter unit 120 (or short “loop filter” 120), is configured to filter the reconstructed block 115 to obtain a filtered block 121, e.g. by applying a de-blocking sample-adaptive offset (SAO) filter or other filters. The filtered block 121 may also be referred to as filtered reconstructed block 121.

Embodiments of the loop filter unit 120 may comprise (not shown in FIG. 1) a filter analysis unit and the actual filter unit, wherein the filter analysis unit is configured to determine loop filter parameters for the actual filter unit.

Embodiments of the loop filter unit 120 may comprise (not shown in FIG. 1) one or a plurality of filters, e.g. one or more of different kinds or types of filters, e.g. connected in series or in parallel or in any combination thereof, wherein each of the filters may comprise individually or jointly with other filters of the plurality of filters a filter analysis unit to determine the respective loop filter parameters.

Embodiments of the loop filter unit 120 may be configured to provide the loop filter parameters to the entropy encoding unit 170, e.g. for entropy encoding and transmission.

The decoded picture buffer 130 is configured to receive and store the filtered block 121 and other previous filtered blocks, e.g. previously reconstructed and filtered blocks 121, of the same current picture or of different pictures, e.g. previously reconstructed pictures, e.g. for inter estimation and/or inter prediction.

The inter estimation unit 142, also referred to as inter picture estimation unit 142, is configured to receive the picture block 101 (current picture block of a current picture) and one or a plurality of previously reconstructed blocks, e.g. reconstructed blocks of one or a plurality of other/different previously decoded pictures 231, for inter estimation (or “inter picture estimation”). E.g. a video sequence may comprise the current picture and the previously decoded pictures 231, or in other words, the current picture and the previously decoded pictures 231 may be part of or form a sequence of pictures forming a video sequence.

The encoder 100 may, e.g., be configured to obtain a reference block from a plurality of reference blocks of the same or different pictures of the plurality of other pictures and provide a reference picture (or e.g. a reference picture index) and/or an offset (spatial offset) between the position (x, y coordinates) of the reference block and the position of the current block as inter estimation parameters 143 to the inter prediction unit 144. This offset is also called motion vector (MV). The inter estimation is also referred to as motion estimation (ME) and the inter prediction also motion prediction (MP).

The inter prediction unit 144 is configured to receive an inter prediction parameter 143 and to perform inter estimation based on/using the inter prediction parameter 143 to obtain an inter prediction block 145.

The intra estimation unit 152 is configured to receive the picture block 101 (current picture block) and one or a plurality of previously reconstructed blocks, e.g. reconstructed neighbor blocks, of the same picture for intra estimation. The encoder 100 may, e.g., be configured to obtain an intra prediction mode from a plurality of intra prediction modes and provide it as intra estimation parameter 153 to the intra prediction unit 154.

Embodiments of the encoder 100 may be configured to select the intra-prediction mode based on an optimization criterion, e.g. minimum residual (e.g. the intra-prediction mode providing the prediction block 155 most similar to the current picture block 101) or minimum rate distortion.

The intra prediction unit 154 is configured to determine based on the intra prediction parameter 153, e.g. the selected intra prediction mode 153, the intra prediction block 155.

Mode selection unit 160 may be configured to perform inter estimation/prediction and intra estimation/prediction, or control the inter estimation/prediction and intra estimation/prediction, and to select a reference block and/or prediction mode (intra or inter prediction mode) to be used as prediction block 165 for the calculation of the residual block 105 and for the reconstruction of the reconstructed block 115.

Embodiments of the mode selection unit 160 may be configured to select the prediction mode, which provides the minimum residual (minimum residual means better compression), or a minimum signaling overhead, or both. The mode selection unit 160 may be configured to determine the prediction mode based on rate distortion optimization (RDO).

The entropy encoding unit 170 is configured to apply an entropy encoding algorithm on the quantized residual coefficients 109, inter prediction parameters 143, intra prediction parameter 153, and/or loop filter parameters, individually or jointly (or not at all) to obtain encoded picture data 171 which can be output by the output 172, e.g. in the form of an encoded bit stream 171.

Embodiments of the encoder 100 may be configured such that, e.g. the buffer unit 116 is not only used for storing the reconstructed blocks 115 for intra estimation 152 and/or intra prediction 154 but also for the loop filter unit 120 (not shown in FIG. 1), and/or such that, e.g. the buffer unit 116 and the decoded picture buffer unit 130 form one buffer. Further embodiments may be configured to use filtered blocks 121 and/or blocks or samples from the decoded picture buffer 130 (both not shown in FIG. 1) as input or basis for intra estimation 152 and/or intra prediction 154.

Embodiments of the encoder 100 may comprise a picture partitioning unit to partition a picture into a set of typically non-overlapping blocks before processing the picture further. Accordingly, embodiments of the encoder 100 may comprise an input 102 configured to receive blocks (video blocks) of pictures of a video sequence (video stream). Pictures may comprise M×N pixels (horizontal dimension×vertical dimension) and the blocks may comprise m×n pixels (horizontal dimension×vertical dimension), and the picture may have a square dimension of m×n pixels.

The term pixels corresponds to picture samples, wherein each of the pixels/samples may comprise one or more color components. For the sake of simplicity, the following description refers to pixels/samples meaning samples of luminance. However, it is noted that the processing of coding blocks of the invention can be applied to any color component including chrominance or components of a color space such as RGB or the like. On the other hand, it may be beneficial to perform motion vector estimation for only one component and to apply the results of the processing to more (or all) components.

Embodiments of the encoder 100 may be adapted to use the same block size for all pictures of a video sequence or to change the block size and the corresponding grid defining the block size and partitioning the picture into the corresponding blocks per picture or a subset of pictures.

For partitioning the pictures into blocks, embodiments of the encoder 100 may comprise a picture partitioning unit (not depicted in FIG. 1).

FIG. 2 shows an example video decoder 200 configured to receive an encoded picture data (bit stream) 171, e.g. encoded by encoder 100, to obtain a decoded picture 231.

The decoder 200 comprises an input 202, an entropy decoding unit 204, an inverse quantization unit 110, an inverse transformation unit 112, a reconstruction unit 114, a buffer 116, a loop filter 120, a decoded picture buffer 130, an inter prediction unit 144, an intra prediction unit 154, a mode selection unit 160 and an output 232. Here, identical reference signs refer to identical or at least functionally equivalent features between the video encoder 100 of FIG. 1 and the video decoder 200 of FIG. 2.

Accordingly, FIG. 1 and FIG. 2 illustrate examples of picture coding apparatuses. The picture coding apparatus may be a picture encoding apparatus, such as the video encoder 100 of FIG. 1, or the picture coding apparatus may be a picture decoding apparatus, such as the video decoder 200 of FIG. 2.

The picture coding apparatus 100 or 200 is configured to receive partitioning information for a current block of picture data. As discussed above, the current block of picture data may be included in a video sequence picture or a still picture. The partitioning information comprises data that describes how a picture is to be partitioned or split into blocks, and optionally data that describes how the blocks are to be partitioned into sub-blocks. That is, the partitioning information comprises data on partitioning configurations which are sets of partitioning operations on blocks and the resulting sub-blocks. For the picture decoding apparatus 200, the partitioning information may comprise e.g. syntax elements included in an input bit stream. The syntax elements may comprise e.g. split flags. For the picture encoding apparatus 100, the partitioning information may be determined e.g. by performing rate-distortion (RD) optimization, i.e. by predefining a set of partitioning configurations and selecting the one that provides a minimum of RD cost. In other words, the partitioning information comprises information on a partitioning configuration of the current block of picture data.

The picture coding apparatus 100 or 200 is further configured to determine a partitioning process for the current block of picture data. The partitioning process may be implemented by a picture partitioning unit (not shown in FIGS. 1 and 2) included in the picture coding apparatus 100 or 200.

In the partitioning process, the current block of picture data is asymmetrically partitioned into two sub-blocks, i.e. a first first-level sub-block of picture data and a second first-level sub-block of picture data such that the first first-level sub-block is smaller than the second first-level sub-block, when the received partitioning information indicates that the current block of picture data is to be partitioned. The terms “first” and “second” in the first and second first-level sub-blocks do not indicate an order or position of the first-level sub-blocks with respect to each other. The asymmetrical partitioning may comprise asymmetrical BT partitioning. Herein, “asymmetrical” indicates that the resulting first-level sub-blocks are asymmetrically located with respect to a center line of the current block of picture data in a direction perpendicular or orthogonal to the direction of the asymmetrical partitioning. Directions may include e.g. vertical and horizontal directions. For example, when the direction of the asymmetrical partitioning is vertical, the resulting first-level sub-blocks are asymmetrically located with respect to the center line of the current block of picture data in the horizontal direction.

Here, the first first-level sub-block being smaller than the second first-level sub-block indicates that a side-length of the first first-level sub-block of picture data is smaller than the side-length of the second first-level sub-block of picture data in a direction perpendicular or orthogonal to the direction of the asymmetrical partitioning. For example, when the asymmetrical partitioning is performed vertically, the side-length of the first first-level sub-block is smaller than the side-length of the second first-level sub-block in a horizontal direction, and when the asymmetrical partitioning is performed horizontally, the side-length of the first first-level sub-block is smaller than the side-length of the second first-level sub-block in a vertical direction. “First-level” indicates a sub-block resulting from only the first partitioning of the current block of picture data. The “side-length” of a sub-block of picture data indicates the length of a side of the sub-block of picture data, the sub-block of picture data being rectangular in shape.

Furthermore, when performing the asymmetrical partitioning, the side-length of the second first-level sub-block of picture data in the direction perpendicular or orthogonal to the direction of the asymmetrical partitioning may be selected such that it can be divided into three parts which each have a length that is a power of two. For example, a side-length of 24 units (e.g. pixels) can be divided to three parts with respective side-lengths of 4 (i.e. 2²) units, 16 (i.e. 2⁴) units, and 4 (i.e. 2²) units. In other words, the side-length of the second first-level sub-block of picture data in the direction perpendicular to the direction of the asymmetrical partitioning is dividable into three portions, each of which has a side-length of a power of two.

When the received partitioning information also indicates that the first first-level sub-block of picture data and/or the second first-level sub-block of picture data is to be partitioned, the indicated ones of the first first-level sub-block of picture data and/or the second first-level sub-block of picture data are symmetrically partitioned into e.g. two or three second-level sub-blocks of picture data. The symmetrical partitioning may comprise e.g. symmetrical BT partitioning or symmetrical TT partitioning. “Second-level” indicates a sub-block resulting from the first and second partitioning of the current block of picture data. Herein, “symmetrical” indicates that the resulting second-level sub-blocks are symmetrically located with respect to a center line of their originating first-level block of picture data in a direction perpendicular or orthogonal to the direction of the respective symmetrical partitioning.

The direction of each symmetrical partitioning depends on the direction of the earlier asymmetrical partitioning. In addition, the direction of each symmetrical partitioning depends on which of the first first-level sub-block of picture data and the second first-level sub-block of picture data is currently the subject of the symmetrically partitioning.

For example, the first first-level sub-block may be symmetrically partitioned into e.g. two or three second-level sub-blocks of picture data horizontally when the earlier asymmetrical partitioning was performed vertically, or the first first-level sub-block may be symmetrically partitioned into e.g. two or three second-level sub-blocks of picture data vertically when the earlier asymmetrical partitioning was performed horizontally. In other words, in case of the first first-level sub-block, the symmetrical partitioning may comprise symmetrically partitioning the first first-level sub-block into at least two second-level sub-blocks of picture data in a direction perpendicular or orthogonal to the direction of the asymmetrical partitioning.

In another example, the second first-level sub-block may be symmetrically partitioned into e.g. two or three second-level sub-blocks of picture data vertically when the earlier asymmetrical partitioning was performed vertically, or the second first-level sub-block may be symmetrically partitioned into e.g. two or three second-level sub-blocks of picture data horizontally when the earlier asymmetrical partitioning was performed horizontally. In other words, in case of the second first-level sub-block, the symmetrical partitioning may comprise symmetrically partitioning the second first-level sub-block of picture data into at least two second-level sub-blocks of picture data in a direction parallel to the direction of the asymmetrical partitioning.

Finally, the partitioning process may optionally be stopped from advancing to any further levels of sub-blocks of picture data. In other words, the determined partitioning process may comprise refraining from further partitioning any of the first-level or second-level sub-blocks of picture data.

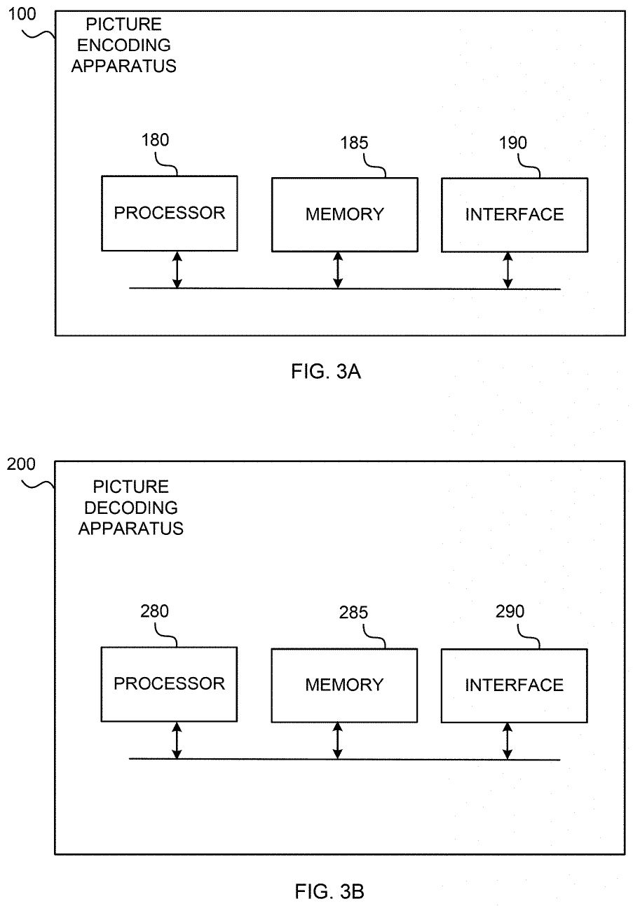

FIG. 3A illustrates a further example of the picture encoding apparatus 100 of FIG. 1. The picture encoding apparatus 100 may comprise a processor 180, a memory 185 and/or an input/output interface 190. The processor 180 may be adapted to perform the functions of one or more of the residual calculation unit 104, transformation unit 106, quantization unit 108, inverse quantization unit 110, inverse transformation unit 112, reconstruction unit 114, loop filter 120, inter estimation unit 142, inter prediction unit 144, intra estimation unit 152, intra prediction unit 154, mode selection unit 160, or entropy encoding unit 170. The input/output interface 190 may be adapted to perform the functions of one or more of the input 102 or output 172. The memory 185 may be adapted to perform the functions of one or more of the buffer 116 or the frame buffer 130.

FIG. 3B illustrates a further example of the picture decoding apparatus 200 of FIG. 2. The picture decoding apparatus 200 may comprise a processor 280, a memory 285 and/or an input/output interface 290. The processor 2180 may be adapted to perform the functions of one or more of the entropy decoding unit 204, inverse quantization unit 110, inverse transformation unit 112, reconstruction unit 114, loop filter 120, inter prediction unit 144, intra prediction unit 154, or mode selection unit 160. The input/output interface 290 may be adapted to perform the functions of one or more of the input 202 or output 232. The memory 285 may be adapted to perform the functions of one or more of the buffer 116 or decoded picture buffer 130.

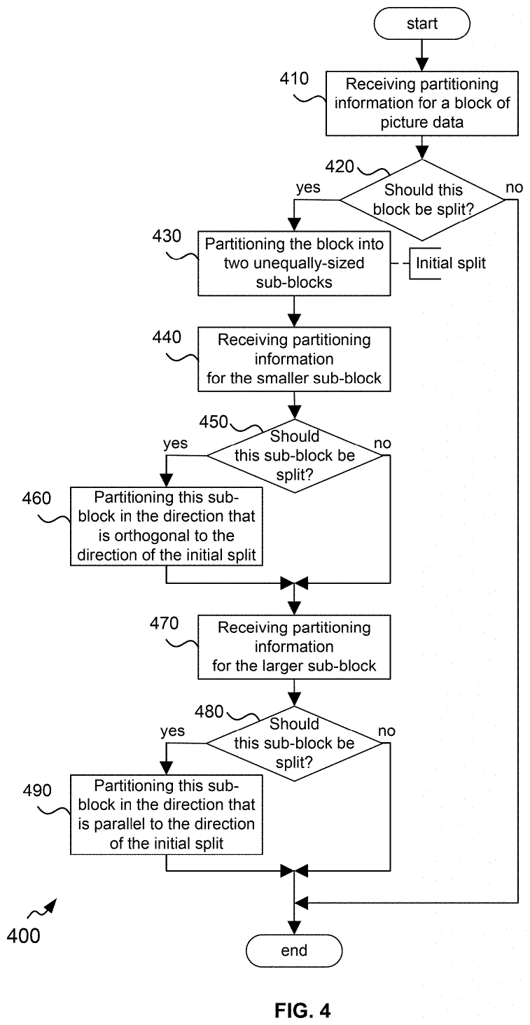

FIG. 4 shows a flow diagram of an example method 400 involving picture coding with asymmetric partitioning.

The method 400 comprises receiving, at a picture coding apparatus, partitioning information for a current block of picture data, step 410. At step 420, the picture coding apparatus determines whether the received partitioning information indicates that the current block of picture data is to be partitioned. If yes, the method proceeds to step 430 (i.e. initial split) in which the current block of picture data is asymmetrically partitioned into a first first-level sub-block of picture data and a second first-level sub-block of picture data such that the first first-level sub-block is smaller than the second first-level sub-block.

At step 440, the picture coding apparatus receives partitioning information for the first first-level sub-block of picture data. At step 450, the picture coding apparatus determines whether the received partitioning information indicates that the first first-level sub-block of picture data is to be partitioned. If yes, the method proceeds to step 460 in which the first first-level sub-block of picture data is symmetrically partitioned into e.g. two or three second-level sub-blocks of picture data in a direction perpendicular or orthogonal to the direction of the asymmetrical partitioning.

At step 470, the picture coding apparatus receives partitioning information for the second first-level sub-block of picture data. At step 480, the picture coding apparatus determines whether the received partitioning information indicates that the second first-level sub-block of picture data is to be partitioned. If yes, the method proceeds to step 490 in which the second first-level sub-block of picture data is symmetrically partitioned into two or three second-level sub-blocks of picture data in a direction parallel to the direction of the asymmetrical partitioning.

Next, the method ends, refraining from further partitioning any of the first-level or second-level sub-blocks of picture data.

The method 400 may be performed by the apparatus 100 or the apparatus 200, e.g. by a picture partitioning unit (not shown in FIGS. 1 and 2) included in the apparatus 100 or the apparatus 200. Further features of the method 400 directly result from the functionalities of the apparatus 100 and 200. The method 400 can be performed by a computer program.

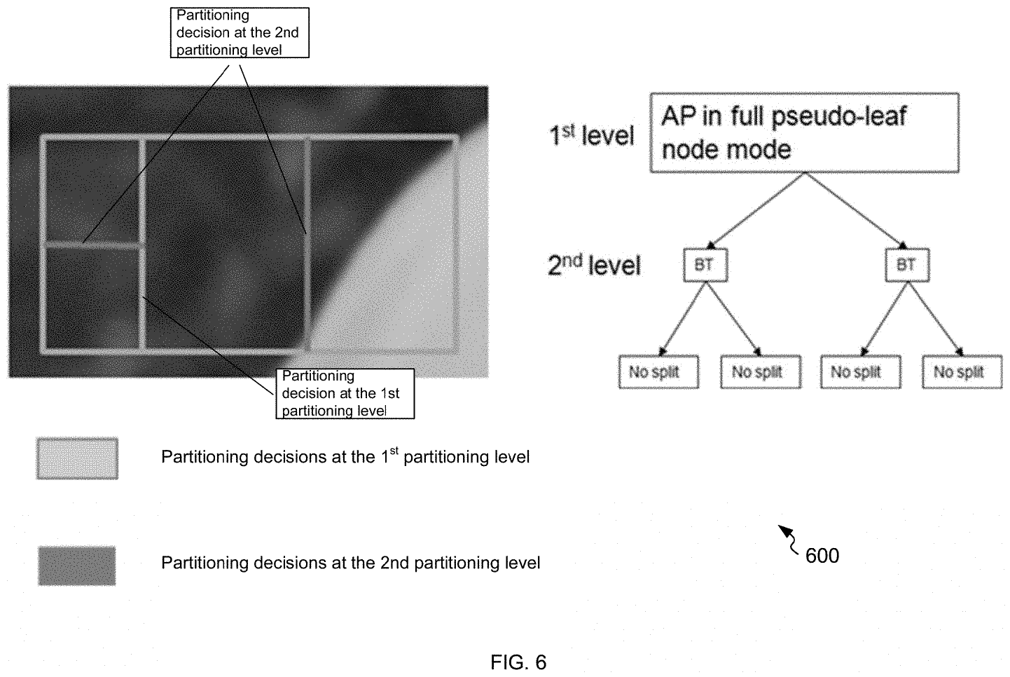

FIGS. 6 to 8 illustrate two-level partitioning according to further examples. The present embodiments aim to constrain parameters of the binary asymmetric partitioning mechanism to exclude modes that appear not frequently. The first of these parameters is the maximum split depth that may equal e.g. two, i.e. a block can be split at two partitioning levels at the most, as shown in diagram 600 of FIG. 6. Moreover, further partitionings of blocks obtained due to applying asymmetric partitioning can be only binary and only symmetric in the example in FIG. 6. Generally speaking, the directions of further splits (i.e. splits after the asymmetric one) may be predefined for each partition. Furthermore, these directions depend on the decisions made at the previous level. As shown in the example in FIG. 6, the first (SP) and second (LP) partitions can be split only in horizontal and vertical directions, respectively.

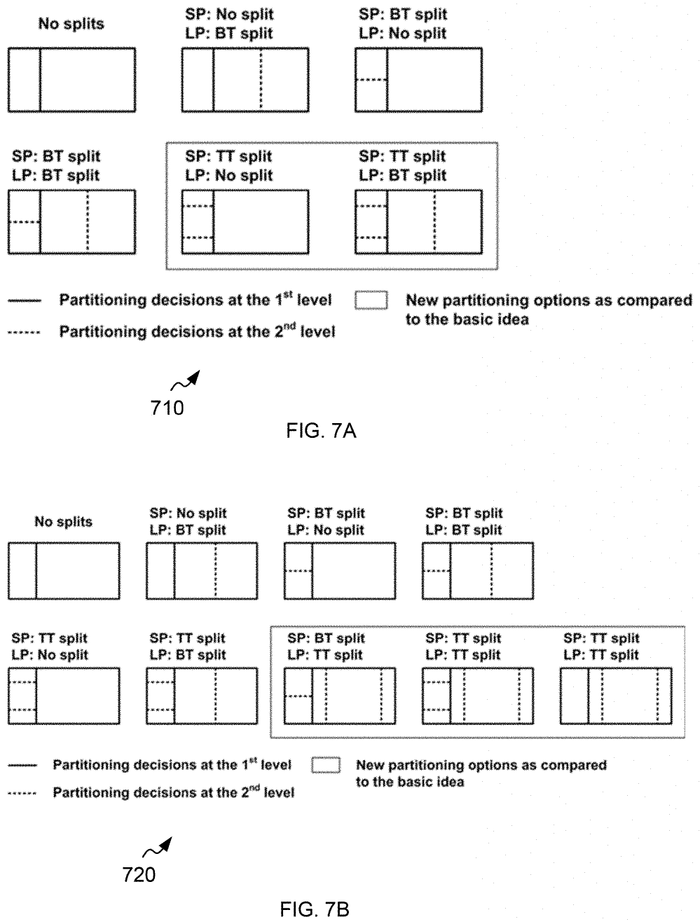

While the direction of SP and LP partitioning is fixed, partitioning type may be other than a binary split. Diagram 710 of FIG. 7A shows additional options of splitting SP and LP as compared to the basic idea. TT partitioning may be applied to the SP thus splitting it into three sub-parts. However, split direction in this case is orthogonal to the direction of the asymmetric partitioning. The possible split type for LP is still limited to the binary one in this example embodiment.

Another extension of the case shown in FIG. 7A is to apply TT partitioning to the LP. Resulting partitioning cases are shown in diagram 720 of FIG. 7B. Split direction is not changed for the LP, but additional partitioning types are enabled for this partitioning.

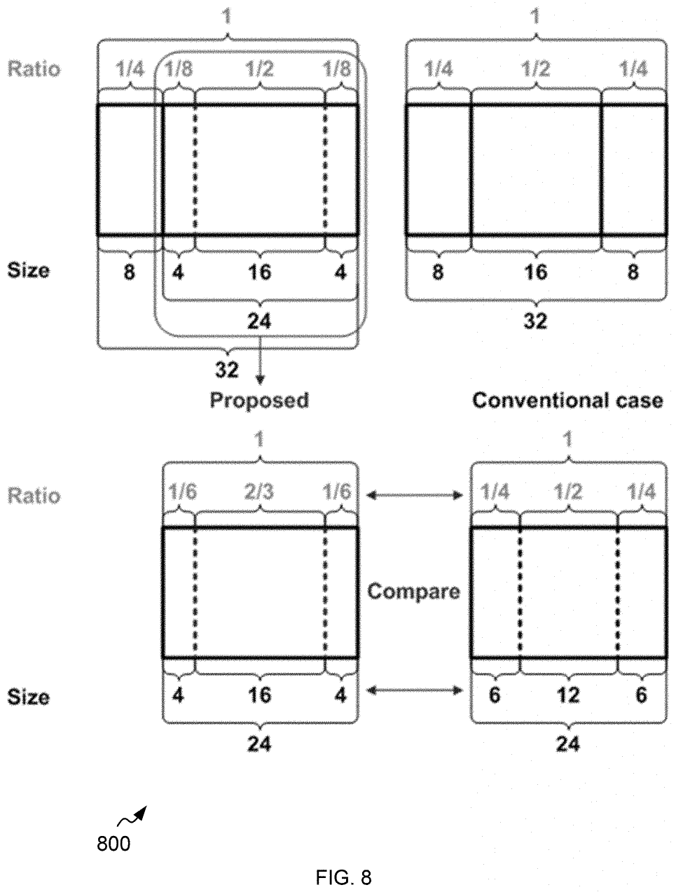

Potential issues in splitting the LP further may rise if the side of the LP that is further split has a size which is not a power of two. Accordingly, if TT partitioning ratio was defined as it is done in conventional TT partitioning, the generated partitions would also have one of their sides unequal to a power of two, as shown on the right side of diagram 800 of FIG. 8. Due to the hardware limitations, it is undesirable to have small blocks with side-lengths other than a power of two.

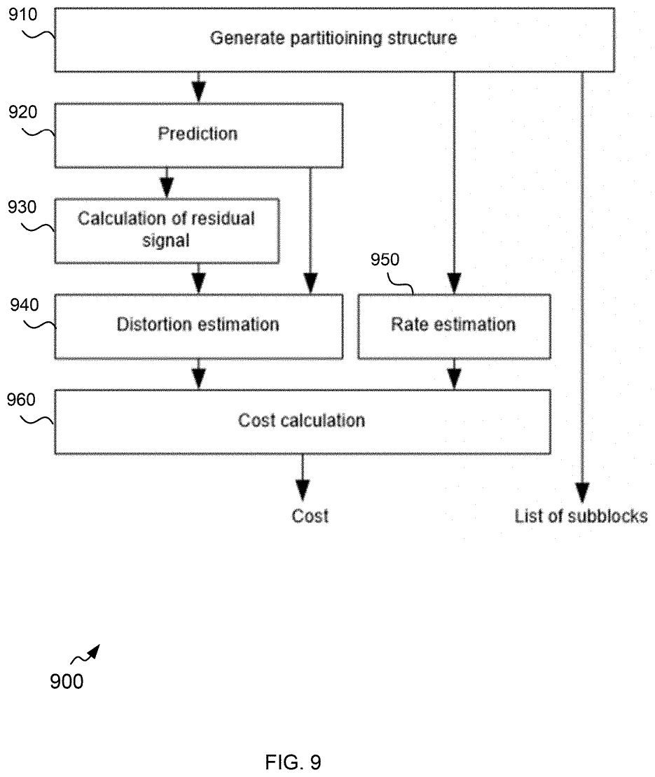

FIG. 9 show a flow diagram 900 illustrating partitioning decision-making according to an example embodiment. Partitioning decisions at the encoder side may be made with taking into account resulting distortion of the reconstructed picture and the number of bits in the bit stream that is required to restore the picture at the decoder side. This rate-distortion optimization procedure requires that the number of bits to encode partitioning information is estimated at the encoding stage. FIG. 9 illustrates this concept.

Steps shown in this figure are performed to obtain various lists of sub-blocks and to estimate cost values for each of the generated lists. The first step 910 of this process is to cover a largest coding unit with sub-blocks, i.e. to generate a partitioning structure represented by a list of sub-blocks. For each of these sub-blocks, a prediction signal is generated, step 920. Selection of the prediction mode can also be performed according a Rate-Distortion Optimization (RDO) based approach. Residual signal is obtained (step 930) by subtracting original picture signal from the prediction signal and applying the following steps to the result: transform, quantization, inverse quantization and inverse transform. This residual signal is then added to the prediction signal thus generating a reconstructed signal used to estimate its distortion (step 940).

The number of bits that is required to obtain the reconstructed signal is estimated at the rate estimation step 950. This step may perform entropy encoding and context modeling similar to how it is done during bit stream generation. However, no output bit stream signal is generated at this step.

Cost calculation step 960 uses estimate distortion and rate values to combine them into a single metrics value that makes it possible to select the best partitioning structure using value comparison operations. Finally, a variant that provides the lowest value of the cost function is selected to be signaled into a bit stream.

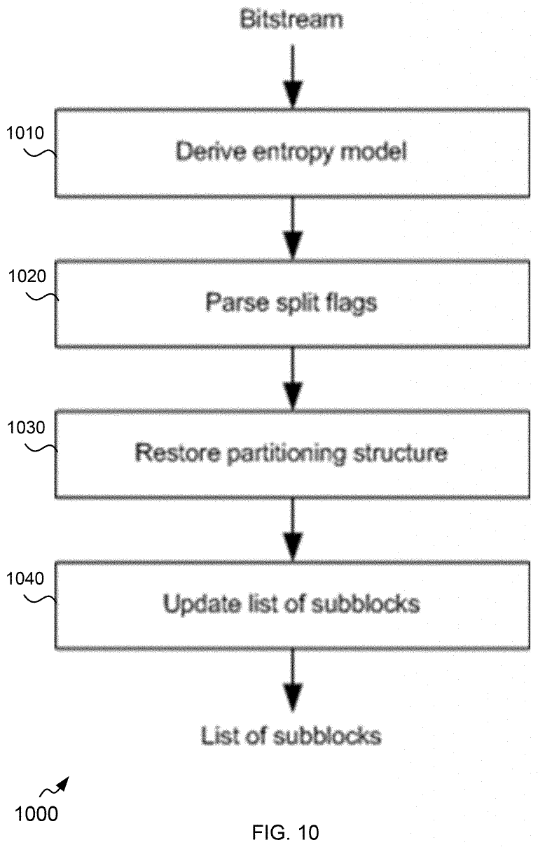

FIG. 10 shows a flow diagram 1000 illustrating a decoding process that is performed for each LCU iteratively and may comprise the following steps. A bit stream is decoded using derived (step 1010) entropy model. A result of this step is used during split flag parsing, step 1020. Subject to a parsed split flag value, a decision is made whether a decoded block is further split into sub-blocks. The partitioning type that is used to split a block is determined at step 1030 of partitioning structure restoration. The step 1030 may use pre-defined limitations of split and corresponding bit stream syntax elements. The final step 1040 is to update a list of sub-blocks that need to be reconstructed. Afterwards, the next block of an LCU will be decoded. When the last block of an LCU has been processed, the next LCU will be decoded in accordance with FIG. 10.

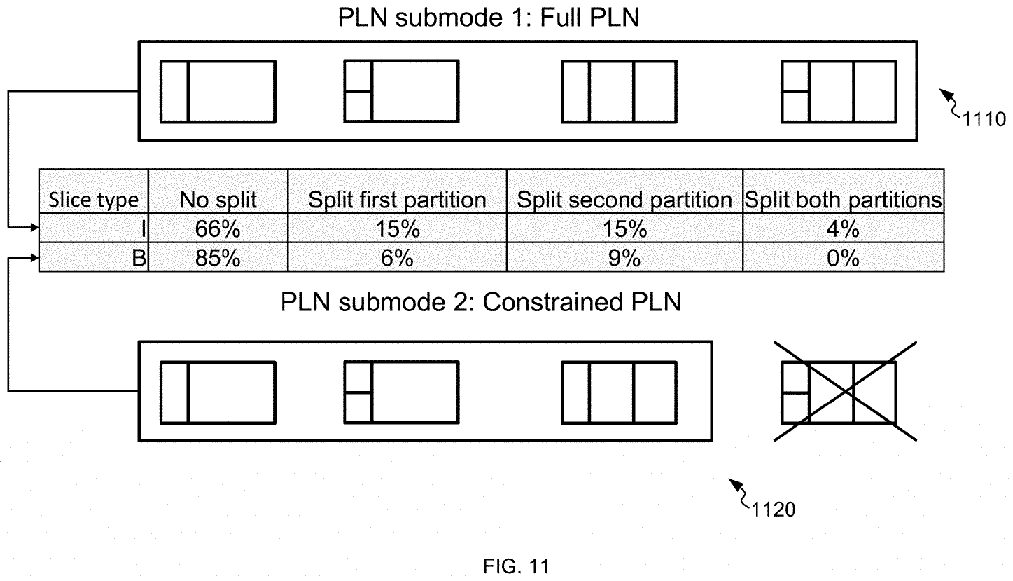

FIG. 11 illustrates typical statistics related to various partitioning decisions. More specifically, FIG. 11 relates to the symmetric BT partitioning decisions of the first and second first-level sub-blocks of picture data. Diagram 1110 illustrates a full pseudo-leaf node (FPLN) sub-mode in which all four partitioning decision combinations for the first and second first-level sub-blocks of picture data may be used. Diagram 1110 also shows typical frequencies of occurrence for both I type slices and B type slices of a video sequence.

When neither the first first-level sub-block nor the second first-level sub-block are partitioned, frequency of occurrence is typically 66% for I type slices and 85% for B type slices. When only the first first-level sub-block is partitioned, frequency of occurrence is typically 15% for I type slices and 6% for B type slices. When only the second first-level sub-block is partitioned, frequency of occurrence is typically 15% for I type slices and 9% for B type slices. When both the first first-level sub-block and the second first-level sub-block are partitioned, frequency of occurrence is typically 4% for I type slices and 0% for B type slices.

Diagram 1120 illustrates a constrained pseudo-leaf node (CPLN) sub-mode in which the three most frequently occurring partitioning decision combinations for the first and second first-level sub-blocks of picture data may be used. In other words, the partitioning decision combination of partitioning both the first first-level sub-block and the second first-level sub-block of diagram 1110 has been dropped due to it having the least amount of occurrences based on the statistics of diagram 1110.

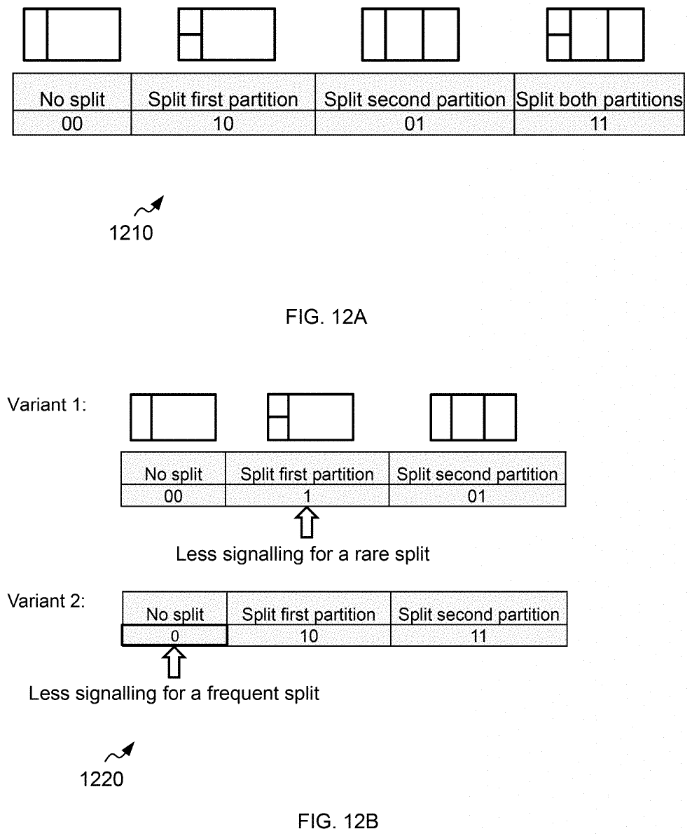

FIG. 12A shows a diagram 1210 illustrating an example of a signaling scheme that may be used e.g. with the partitioning decisions of diagram 1110 of FIG. 11 using a CABAC (Context-Adaptive Binary Arithmetic Coding) binarizer with fixed length code. ‘00’ may be used to signal that neither the first first-level sub-block nor the second first-level sub-block are to be partitioned. ‘10’ may be used to signal that only the first first-level sub-block is to be partitioned. ‘01’ may be used to signal that only the second first-level sub-block is to be partitioned. ‘11’ may be used to signal that both the first first-level sub-block and the second first-level sub-block are to be partitioned.

FIG. 12B shows a diagram 1220 illustrating two variant examples of a signaling scheme that may be used e.g. with the partitioning decisions of diagram 1120 of FIG. 11. Here, a truncated unary code is used as a binarizer.

In the first variant, ‘00’ may be used to signal that neither the first first-level sub-block nor the second first-level sub-block are to be partitioned. ‘1’ may be used to signal that only the first first-level sub-block is to be partitioned. ‘01’ may be used to signal that only the second first-level sub-block is to be partitioned. This variant allows less signaling overhead for rarely occurring partitionings in view of the statistics of diagram 1110.

In the second variant, ‘0’ may be used to signal that neither the first first-level sub-block nor the second first-level sub-block are to be partitioned. ‘10’ may be used to signal that only the first first-level sub-block is to be partitioned. ‘11’ may be used to signal that only the second first-level sub-block is to be partitioned. This variant allows less signaling overhead for frequently occurring partitionings in view of the statistics of diagram 1110.

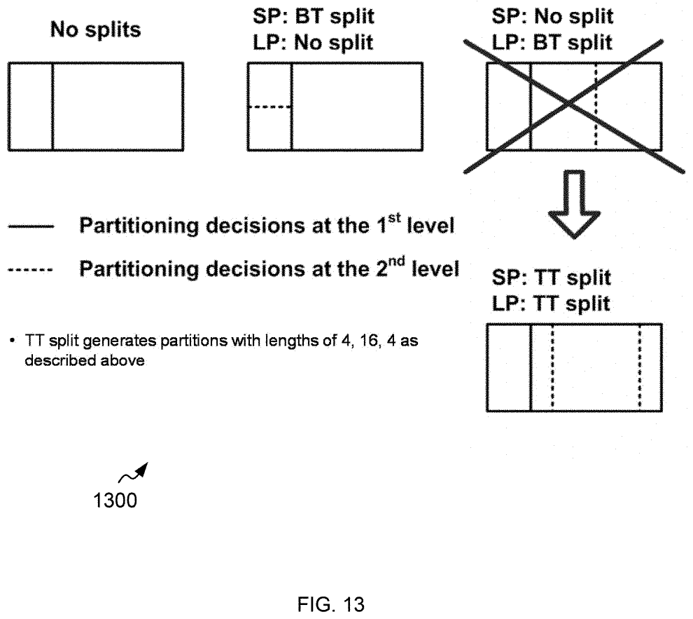

FIG. 13 shows a diagram 1300 further illustrating an example of the partitioning decisions. Here, symmetric BT partitioning of the second first-level sub-block is replaced with symmetric TT partitioning of the second first-level sub-block. Furthermore, as described above, the side-length of the second first-level sub-block of picture data in the direction perpendicular to the direction of the asymmetrical partitioning may be selected such that it can be divided into three parts which each have a length that is a power of two, e.g. a side-length of 24 units can be divided to three parts with respective side-lengths of 4 (i.e. 2²) units, 16 (i.e. 2⁴) units, and 4 (i.e. 2²) units.

The image coding apparatus and the corresponding method have been described in conjunction with various embodiments herein. However, other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality.

An embodiment of the invention comprises or is a computer program comprising program code for performing any of the methods described herein, when executed on a computer.

An embodiment of the invention comprises or is a computer readable medium comprising a program code that, when executed by a processor, causes a computer system to perform any of the methods described herein.

The person skilled in the art will understand that the “blocks” (“units”) of the various figures represent or describe functionalities of embodiments of the invention (rather than necessarily individual “units” in hardware or software) and thus describe equally functions or features of apparatus embodiments as well as method embodiments (unit equaling step).

As explained above, the arrangements for image coding may be implemented in hardware, such as the video encoding apparatus or video decoding apparatus as described above, or as a method. The method may be implemented as a computer program. The computer program is then executed in a computing device.

The apparatus, such as video decoding apparatus, video encoding apparatus or any other corresponding image coding apparatus is configured to perform one of the methods described above. The apparatus comprises any necessary hardware components. These may include at least one processor, at least one memory, at least one network connection, a bus and similar. Instead of dedicated hardware components it is possible to share, for example, memories or processors with other components or access at a cloud service, centralized computing unit or other resource that can be used over a network connection.

Depending on certain implementation requirements of the inventive methods, the inventive methods can be implemented in hardware or in software or in any combination thereof.

The implementations can be performed using a digital storage medium, in particular a floppy disc, CD, DVD or Blu-Ray disc, a ROM, a PROM, an EPROM, an EEPROM or a Flash memory having electronically readable control signals stored thereon which cooperate or are capable of cooperating with a programmable computer system such that an embodiment of at least one of the inventive methods is performed.

A further embodiment of the present disclosure is or comprises, therefore, a computer program product with a program code stored on a machine-readable carrier, the program code being operative for performing at least one of the inventive methods when the computer program product runs on a computer.

In other words, embodiments of the inventive methods are or comprise, therefore, a computer program having a program code for performing at least one of the inventive methods when the computer program runs on a computer, on a processor or the like.

A further embodiment of the present disclosure is or comprises, therefore, a machine-readable digital storage medium, comprising, stored thereon, the computer program operative for performing at least one of the inventive methods when the computer program product runs on a computer, on a processor or the like.

A further embodiment of the present disclosure is or comprises, therefore, a data stream or a sequence of signals representing the computer program operative for performing at least one of the inventive methods when the computer program product runs on a computer, on a processor or the like.

A further embodiment of the present disclosure is or comprises, therefore, a computer, processor or any other programmable logic device adapted to perform at least one of the inventive methods.

A further embodiment of the present disclosure is or comprises, therefore, a computer, processor or any other programmable logic device having stored thereon the computer program operative for performing at least one of the inventive methods when the computer program product runs on the computer, processor or the any other programmable logic device, e.g. a FPGA (Field Programmable Gate Array) or an ASIC (Application Specific Integrated Circuit).

While the aforegoing was particularly shown and described with reference to particular embodiments thereof, it is to be understood by those skilled in the art that various other changes in the form and details may be made, without departing from the spirit and scope thereof. It is therefore to be understood that various changes may be made in adapting to different embodiments without departing from the broader concept disclosed herein and comprehended by the claims that follow.

What is claimed is:

1. A picture coding apparatus, configured to:
receive partitioning information for a current block of picture data; and
perform a partitioning process for the current block of picture data comprising:
in response to the received partitioning information indicating that the current block of picture data is to be partitioned, asymmetrically partitioning the current block of picture data into a first first-level sub-block of picture data and a second first-level sub-block of picture data, the first first-level sub-block being smaller than the second first-level sub-block; and
in response to the received partitioning information further indicating that at least one of the first first-level sub-block of picture data or the second first-level sub-block of picture data is to be partitioned, symmetrically partitioning the indicated ones of the at least one of the first first-level sub-block of picture data or the second first-level sub-block of picture data into at least two second-level sub-blocks of picture data, the direction of the symmetrical partitioning being dependent on the direction of the asymmetrical partitioning and on which of the first first-level sub-block of picture data and the second first-level sub-block of picture data is the subject of the symmetrical partitioning.

2. The picture coding apparatus according to claim 1, wherein the partitioning process to be determined for the current block of picture data further comprises refraining from further partitioning any of the first-level or second-level sub-blocks of picture data.

3. The picture coding apparatus according to claim 1, wherein the first first-level sub-block being smaller than the second first-level sub-block comprises the side-length of the first first-level sub-block of picture data being smaller than the side-length of the second first-level sub-block of picture data in a direction perpendicular to the direction of the asymmetrical partitioning.

4. The picture coding apparatus according to claim 1, wherein the symmetrical partitioning of the first first-level sub-block of picture data comprises symmetrically partitioning the first first-level sub-block of picture data into the at least two second-level sub-blocks of picture data in a direction perpendicular to the direction of the asymmetrical partitioning.

5. The picture coding apparatus according to claim 1, wherein the symmetrical partitioning of the second first-level sub-block of picture data comprises symmetrically partitioning the second first-level sub-block of picture data into the at least two second-level sub-blocks of picture data in a direction parallel to the direction of the asymmetrical partitioning.

6. The picture coding apparatus according to claim 3, wherein the side-length of the second first-level sub-block of picture data in the direction perpendicular to the direction of the asymmetrical partitioning is dividable into three portions, each of which has a side-length of a power of two.

7. The picture coding apparatus according to claim 1, wherein the asymmetrical partitioning comprises asymmetrical binary tree partitioning.

8. The picture coding apparatus according to claim 1, wherein the symmetrical partitioning comprises symmetrical binary tree partitioning or symmetrical triple tree partitioning.

9. The picture coding apparatus according to claim 1, wherein the partitioning information comprises information on a partitioning configuration of the current block of picture data.

10. The picture coding apparatus according to claim 1, wherein the picture coding apparatus comprises a picture encoding apparatus (100).

11. The picture coding apparatus according to claim 1, wherein the picture coding apparatus comprises a picture decoding apparatus.

12. The picture coding apparatus according to claim 1, wherein the current block of picture data is included in a video sequence picture or a still picture.

13. A method of picture coding, comprising:
receiving, at a picture coding apparatus, partitioning information for a current block of picture data; and
performing, by the picture coding apparatus, a partitioning process for the current block of picture data comprising:
in response to the received partitioning information indicating that the current block of picture data is to be partitioned, asymmetrically partitioning the current block of picture data into a first first-level sub-block of picture data and a second first-level sub-block of picture data, the first first-level sub-block being smaller than the second first-level sub-block;
in response to the received partitioning information further indicating that at least one of the first first-level sub-block of picture data or the second first-level sub-block of picture data is to be partitioned, symmetrically partitioning the indicated ones of the at least one of the first first-level sub-block of picture data or the second first-level sub-block of picture data into at least two second-level sub-blocks of picture data, the direction of the symmetrical partitioning being dependent on the direction of the asymmetrical partitioning and on which of the first first-level sub-block of picture data and the second first-level sub-block of picture data is the subject of the symmetrical partitioning.

14. The method according to claim 13, wherein the partitioning process to be determined for the current block of picture data further comprises refraining from further partitioning any of the first-level or second-level sub-blocks of picture data.

15. The method according to claim 13, wherein the first first-level sub-block being smaller than the second first-level sub-block comprises the side-length of the first first-level sub-block of picture data being smaller than the side-length of the second first-level sub-block of picture data in a direction perpendicular to the direction of the asymmetrical partitioning.

16. The method according to claim 13, wherein the symmetrical partitioning of the first first-level sub-block of picture data comprises symmetrically partitioning the first first-level sub-block of picture data into the at least two second-level sub-blocks of picture data in a direction perpendicular to the direction of the asymmetrical partitioning.

17. The method according to claim 13, wherein the symmetrical partitioning of the second first-level sub-block of picture data comprises symmetrically partitioning the second first-level sub-block of picture data into the at least two second-level sub-blocks of picture data in a direction parallel to the direction of the asymmetrical partitioning.

18. The method according to claim 15, wherein the side-length of the second first-level sub-block of picture data in the direction perpendicular to the direction of the asymmetrical partitioning is dividable into three portions, each of which has a side-length of a power of two.

19. A computer program comprising program code configured to perform a method according to of claim 13, when the computer program is executed on a computing device.
